(19) United States
(12) Patent Application Publication
(10) Pub. No.: US 2020/0330192 A1
(43) Pub. Date: Oct. 22, 2020

(54) DENTAL IMPLANT WITH PARTIAL TRANSMUCOSAL PENETRATION, AND PROSTHETIC ASSEMBLY COMPRISING SUCH AN IMPLANT

(71) Applicant: ANTHOGYR, Sallanches (CH)

(72) Inventor: Hervé RICHARD, Notre Dame de Bellecombe (FR)

(21) Appl. No.: 16/764,007

(22) PCT Filed: Dec. 14, 2018
(86) PCT No.: PCT/IB2018/060124

§ 371 Date: May 14, 2020

(30) Foreign Application Priority Data
Dec. 18, 2017 (FR) 17 62369

(51) Int. Cl. A61C 8/00

(52) U.S. Cl. CPC A61C 8/0068; A61C 8/0012; A61C 8/0074; A61C 8/0069

(57) ABSTRACT

A dental implant, extending along a first longitudinal axis between a proximal end and a distal end, includes a proximal endosseous section designed to be buried in the patient's jawbone, extended away from the proximal end by a distal implant section designed to emerge from the patient's jawbone, and an inner connection housing extending from the distal end towards the proximal end. The distal implant section extends at a height along the first longitudinal axis towards the distal end from a base to an apex, and flares from the base to the apex away from the first longitudinal axis. The base has a diameter smaller than a diameter of the proximal endosseous section, so as to form a first annular groove. The distal implant section includes an outer surface having a roughness less than or equal to 0.2 μm. The height at which the distal implant section extends from the base to the apex is between 1.2 mm and 1.5 mm.

### TECHNICAL FIELD OF THE INVENTION

The present invention relates to the field of dentistry and more particularly to a dental implant for insertion into the jawbone of the patient, and to a prosthetic assembly comprising such an implant.

Generally, a dental implant extends along a first longitudinal axis between a proximal end and a distal end and has at least:

a proximal endosseous portion intended to be embedded in the jawbone of the patient,

an inner connection recess extending from the distal end and in the direction of the proximal end.

Dental implants are known that are intended to be embedded entirely in the bone, so as to lie flush with the level of the bone (juxta-osseous placement) or to be situated very slightly below the level of the bone. These dental implants are currently referred to as bone level implants. Three implantation protocols are conceivable for bone level implants.

A first implantation protocol is one in which, after implantation in the bone, the inner connection recess is closed with the aid of a closure piece, above which the practitioner sutures the soft tissues. The dental implant is then said to be in the setting position. After a few months, the practitioner must remove the closure piece and replace it with a healing piece. Before doing this, the practitioner carries out an examination to determine the location of the dental implant and then locally cuts the gum in order to extract the closure piece (this is called the second surgical stage). The practitioner then inserts the healing piece into the dental implant. During the second surgical stage, the gum is attacked. Bleeding occurs in the immediate vicinity of the dental implant and of the bone, and the sealing barrier formed by the gum (by its conjunctive attachment) between the bone and the oral environment is damaged. The healing piece is later removed in order to permit the engagement of a dental prosthetic component, for example a screw-retained dental abutment or screw-retained dental prosthesis, in the inner connection recess. Once again, the conjunctive attachment of the gum (attachment of the part of the epithelium closest to the bone) to the healing piece is broken: bleeding occurs in the immediate vicinity of the dental implant and of the bone, and the sealing barrier between the bone and the oral environment is damaged. These repeated attacks on the gum and this bleeding make the quality of the osseointegration of the dental implant uncertain.

A second implantation protocol involves inserting a healing piece directly into the dental implant, without the step of placing the implant in the setting position. The second surgical stage is avoided. However, the removal of the healing piece still breaks the conjunctive attachment of the gum that has formed around the healing piece. The gum is therefore still attacked, and bleeding takes place, making the quality of the osseointegration of the dental implant uncertain.

If the quality of the bone allows, a third implantation protocol involves inserting a temporary dental prosthetic component directly into the dental implant, without the steps of placing the implant in the setting position with a closure piece and of healing with a healing piece, so as to permit immediate functioning of the dental implant. However, the temporary dental prosthetic component has to be removed some time later so as to allow the engagement of the (final) dental prosthetic component, for example a screw-retained dental abutment or a screw-retained dental prosthesis, in the inner connection recess. The removal of the temporary dental prosthetic component further impairs the conjunctive attachment of the gum that adheres to the temporary dental prosthetic component. The gum is therefore still attacked, and bleeding takes place, making the quality of the osseointegration of the dental implant uncertain.

In order to limit the attack on the gum, dental implants are sometimes used that are intended to be embedded only partially in the bone, these dental implants having a proximal endosseous portion which is continued, away from the proximal end, by a distal implant portion intended to protrude from the jawbone of the patient. These dental implants are intended to extend above the level of the bone and to continue to the level of the surface of the gum or slightly below. These dental implants, intended to pass fully through the mucosa, are commonly referred to as tissue level implants.

When placing a tissue level implant in position, the practitioner sutures the soft tissues around the distal implant portion. The conjunctive attachment of the gum forms around the distal implant portion, which is not removable (not without extracting the whole dental implant).

The disadvantage is that any receding of the gum, however slight, very quickly reveals the distal implant portion (which is most often gray because of its generally metallic material), which is very unsightly.

The document FR 2 942 952 A1 describes a dental implant with a threaded proximal endosseous portion intended to be embedded in the jawbone of the patient, the proximal endosseous portion being continued by a distal implant portion, which is cylindrical and has no thread. At its base connecting it to the adjacent proximal endosseous portion, this cylindrical distal implant portion has a diameter which is equal to the diameter of the adjacent proximal endosseous portion.

The documents FR 2 931 056 A1 and U.S. Pat. No. 5,022,860 A describe a dental implant with a threaded proximal endosseous portion intended to be embedded in the jawbone of the patient, the proximal endosseous portion being continued by a distal implant portion which widens away from the proximal endosseous portion and which has no thread. At its base connecting it to the adjacent proximal endosseous portion, the widened distal implant portion has a diameter which is equal to the diameter of the adjacent proximal endosseous portion.

The document EP 3 034 033 A1 describes a dental implant with a threaded proximal endosseous portion intended to be embedded in the jawbone of the patient, the proximal endosseous portion being continued by a distal implant portion, which is cylindrical and which, at its top, is provided with a bevel that gives it a generally convergent appearance. At its base connecting it to the adjacent proximal endosseous portion, the distal implant portion has a diameter which is greater than the diameter of the adjacent proximal endosseous portion, as is reflected by the presence of a slight shoulder with a facet oriented toward the proximal end of the implant.

### DISCLOSURE OF THE INVENTION

A problem addressed by the present invention is to make available a dental implant that can be placed in the patient's mouth in a way that limits the risks of aggression of the gum, more particularly of the conjunctive attachment thereof.

At the same time, the present invention aims to limit the risk of the dental implant appearing unsightly in the event of the gum receding.

To achieve these and other objects, the invention makes available a dental implant extending along a first longitudinal axis between a proximal end and a distal end, comprising:

a proximal endosseous portion intended to be embedded in the jawbone of the patient,

a distal implant portion continuing the proximal endosseous portion away from the proximal end and intended to protrude from the jawbone of the patient, said distal implant portion comprising an outer surface having a roughness Ra of less than or equal to 0.2 μm,

an inner connection recess extending from the distal end and in the direction of the proximal end;

according to the invention:

the distal implant portion extends by a height along the first longitudinal axis in the direction of the distal end from a base to a top, widening from the base to the top in the direction away from the first longitudinal axis,

the base has a diameter smaller than a diameter of the adjacent proximal endosseous portion, so as to form a first annular groove,

the height by which the distal implant portion extends from its base to its top is between 1.2 mm and 1.5 mm.

The distal implant portion form a continuation of the proximal endosseous portion, such that the assembly composed of the two portions is formed in one piece.

When such an implant is inserted into the patient's bone with its proximal endosseous portion embedded in the bone and its distal implant portion protruding from the bone, the practitioner sutures the gum around the distal implant portion. The conjunctive attachment of the gum thus forms around the distal implant portion, in the constriction afforded by the first annular groove, and is then not attacked when a closure piece, a healing piece or a temporary dental prosthetic component is removed. A satisfactory sealing barrier between the bone and the oral environment is thus maintained.

The constriction of the gum in the first annular groove makes it possible to form a baffle that contributes to improving the seal by limiting the risks of impurities entering between the proximal endosseous portion and the jawbone.

The surface state of the distal implant portion provides non-aggressive contact with the gum and at the very least limits the risk of the gum receding radially away from the distal implant portion. Moreover, the height of said distal implant portion is sufficiently high to permit a satisfactory conjunctive attachment (especially in terms of sealing to protect the bone below) and sufficiently low to limit the risks of the gum receding, through reduction of the height of the gum, and causing an unsightly view of the dental implant.

Preferably, the dental implant can have a maximum external diameter of less than or equal to 3 mm. Such a diameter permits insertion in zones where the available space is small (particularly in the anterior part of the jaw).

Advantageously, the ratio between the diameter of the adjacent proximal endosseous portion and the diameter of the base can be between 1.09 and 1.50. Such a ratio permits a constriction of the gum in the first annular groove, forming a baffle that greatly improves the seal.

Preferably, the endosseous portion can be provided with an external thread which extends in the direction of the distal end of the dental implant and which is interrupted before the first annular groove. The baffle (hence the seal) is thus uniform in all radial directions away from the first longitudinal axis. The proximal endosseous portion can thus begin, away from the distal implant portion, with a cylindrical portion that sealingly closes the orifice of the hole receiving the dental implant.

Advantageously, the dental implant is made of titanium, or titanium alloy, or of zirconia, or zirconia alloy.

Preferably, the distal implant portion can be anodized in a pink color. Therefore, if the gum were unfortunately to recede, despite everything, and render the distal implant portion visible, the pink color of the latter would limit the esthetic loss.

Advantageously, the inner connection recess comprises a portion of non-circular cross section. The portion of non-circular cross section can cooperate in shape with a portion (also having a non-circular cross section) of a dental prosthetic component so as to permit indexing of the latter about the first longitudinal axis.

Preferably, the inner connection recess can comprise, in the distal implant portion, a frustoconical inner bearing surface widening toward the distal end, away from the first longitudinal axis. Such a bearing surface is able to cooperate by conical fitting with a proximal male portion of a dental prosthetic component. A conical fitting provides a good seal and helps to limit the risk of infiltration or stagnation of impurities (bacteria in particular) that can lead to receding of the gums.

Advantageously, the distal implant portion can comprise a frustoconical outer surface having an angle substantially equal to that of the frustoconical inner bearing surface. The distal implant portion thus has a wall of substantially constant thickness over its entire height, which helps to promote a homogeneous distribution of the mechanical stresses between the dental component and the dental implant.

According to another aspect of the present invention, an assembly is made available comprising:

a dental implant as described above,

a dental prosthetic component in the form of a dental abutment or dental prosthesis, comprising a proximal male portion intended to be received by conical fitting in the frustoconical inner bearing surface of the dental implant,

in which the dental prosthetic component comprises a middle portion, adjacent to the proximal male portion and having an external cross section that increases progressively away from the proximal male portion so as to form a second annular groove with the distal end of the dental implant.

Dentists often recommend cleaning the teeth with dental floss. Unfortunately, patients using dental floss may sometimes cause the latter to penetrate the conjunctive attachment of the gum, sometimes even breaking said attachment with the dental floss. This again causes bleeding, in the immediate vicinity of the dental implant and of the bone, and a deterioration of the sealing barrier formed by the gum between the bone and the oral environment.

The risk of the conjunctive attachment of the gum being damaged by dental floss is limited here by means of the second annular groove formed just above the distal implant portion after the dental prosthetic component has been joined to the dental implant. When the dental floss descends along the dental prosthetic component (bearing radially on said dental prosthetic component), it enters the second groove, which prevents it from descending farther if the patient does not release the tension exerted by pulling on the two strands of the dental floss. Upon penetration of the dental floss into the second groove, the dental floss jolts in a way that is perceptible to the patient, and the latter then stops lowering the dental floss along the first longitudinal axis. The conjunctive attachment of the gum formed in the first groove is then preserved from any damage caused by contact with the dental floss.

Preferably, the ratio between the diameter of the top and the diameter of the proximal male portion of the dental prosthetic component at the level of said top, when the dental prosthetic component is engaged in the frustoconical inner bearing surface of the dental implant, can be between 1.2 and 1.4.

Such a constriction makes it possible on the one hand to maintain sufficient dimensions for the proximal male portion, such that it has mechanical characteristics allowing it to withstand the forces of mastication. Moreover, such a constriction on the other hand permits a satisfactory retention of the dental floss during its descent along the first longitudinal axis (at the very least noticeable to the patient).

Advantageously, provision can be made that:

the dental prosthetic component is in the form of a screw-retained dental abutment or a screw-retained dental prosthesis, comprising a through-opening for the passage of a fixation screw,

the inner connection recess comprises an internally threaded proximal portion intended to receive the fixation screw by screwing.

Preferably, provision can be made that:

the inner connection recess comprises a portion of non-circular cross-section,

the proximal male portion of the dental prosthetic component comprises a portion of non-circular cross section adapted to cooperate with the portion of non-circular cross section of the inner connection recess for rotational indexing of the dental prosthetic component with respect to the dental implant about the first longitudinal axis.

### BRIEF DESCRIPTION OF THE DRAWINGS

Other subjects, features and advantages of the present invention will become clear from the following description of particular embodiments, with reference to the accompanying figures, in which:

FIG. 1 is a side view, in longitudinal section, of a dental implant according to a particular embodiment of the present invention;

FIG. 2 is a side view of the dental implant of FIG. 1;

FIG. 3 is a view from above, and in cross section, of the dental implant of FIG. 1;

FIG. 4 is an exploded side view of an assembly according to a particular embodiment of the present invention, comprising the dental implant of FIG. 1 and a dental prosthetic component in the form of a screw-retained dental abutment:

FIG. 5 is a side view, in longitudinal section, of the assembly of FIG. 4 in the assembled state:

FIG. 6 is an exploded side view of an assembly according to a particular embodiment of the present invention, comprising the dental implant of FIG. 1 and a dental prosthetic component of a screw-retained dental prosthesis;

FIG. 7 is a side view, in longitudinal section, of the assembly of FIG. 6 in the assembled state; and

FIG. 8 is a side view of the assembly of FIG. 5, schematically indicating its position after insertion into the jawbone of a patient.

### DESCRIPTION OF THE PREFERRED EMBODIMENTS

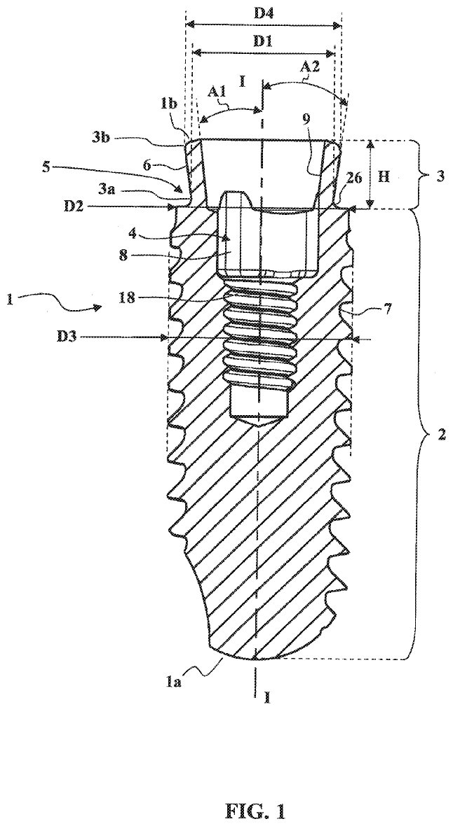

FIGS. 1 to 3 illustrate a particular embodiment of a dental implant 1 according to the present invention.

This dental implant 1 extends along a first longitudinal axis I-I between a proximal end 1a and a distal end 1b and comprises:

a proximal endosseous portion 2 intended to be embedded in the jawbone of the patient, continued away from the proximal end 1a by a distal implant portion 3 intended to protrude from the jawbone of the patient,

an inner connection recess 4 extending from the distal end 1b and in the direction of the proximal end 1a.

With the distal implant portion being a continuation of the proximal endosseous portion, said portions are formed in one piece, as is indicated by hatching in the sectional view of FIG. 1.

The distal implant portion 3 extends by a height H along the first longitudinal axis 11 toward the distal end 1b from a base 3a to a top 3b, widening from the base 3a toward the top 3b away from the first longitudinal axis I-I.

The base 3a has a diameter D1 less than a diameter D2 of the proximal portion 2, so as to form a first annular groove 5.

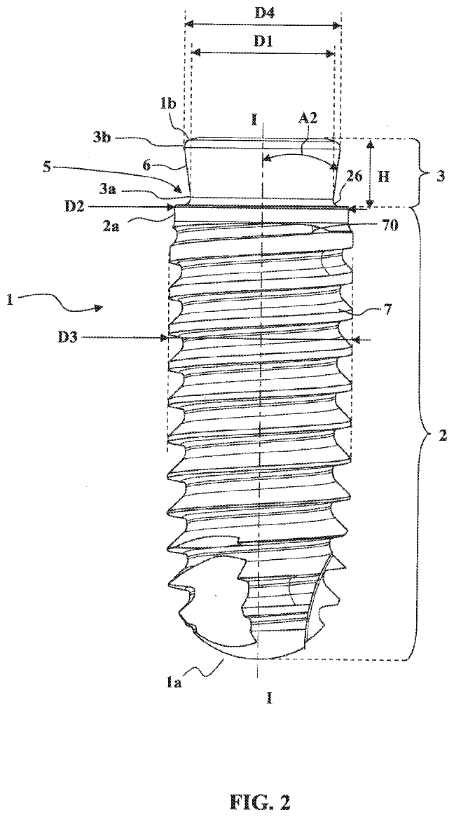

In FIGS. 1 and 2, it will be seen that the distal implant portion 3 connects to the adjacent proximal endosseous portion 2 via a fillet 26 (optional; intended to limit the phenomenon of concentration of mechanical stress in this bonding zone). The diameter D1 of the base 3a is here the smallest diameter of the distal implant portion 3 and is therefore taken just above the fillet 26.

The distal implant portion 3 comprises an outer surface 6 having a roughness Ra of less than or equal to 0.2 μm.

The height by which the distal implant portion 3 extends from its base 3a to its top 3b is between 1.2 mm and 1.5 mm.

The dental implant 1 has a maximum external diameter D3 of less than or equal to 3 mm in order to allow implantation in zones where the available space is small.

The ratio between the diameter D2 of the adjacent proximal endosseous portion 2 and the diameter D1 of the base 3a is between 1.09 and 1.50.

The inner connection recess 4 comprises, in the distal implant portion 3, a frustoconical inner bearing surface 9 widening at an angle A1 toward the distal end 1b away from the first longitudinal axis I-I. The outer surface 6 of the distal implant portion 3 is also frustoconical and has an angle A2 substantially equal to the angle A1 of the frustoconical inner bearing surface 9.

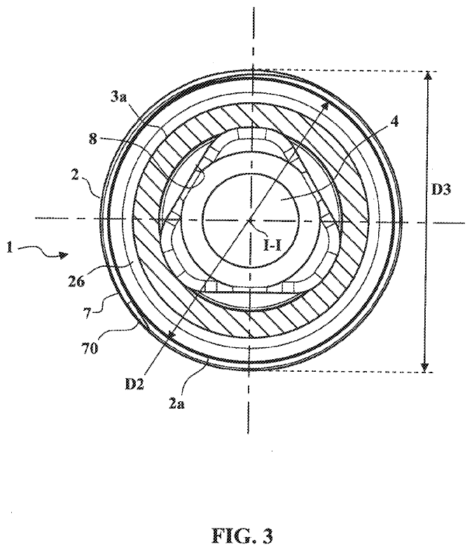

FIG. 2 shows more particularly that the endosseous portion 2 is provided with an external thread 7 which extends toward the distal end 1b of the dental implant 1 and is interrupted before the first annular groove 5. This interruption 70 is also visible in FIG. 3. FIG. 3 is a cross-sectional view of the dental implant 1 at the base 3a and shows that the adjacent proximal endosseous portion 2, seen from above, is in the form of a disk of diameter D2. The proximal endosseous portion 2 starts here, away from the distal implant portion 3, with a cylindrical portion 2a of circular cross section with diameter D2.

The dental implant 1 is made of titanium, or titanium alloy, or of zirconia, or zirconia alloy. The distal implant portion 3 is preferably anodized in a pink color on its outer surface 6.

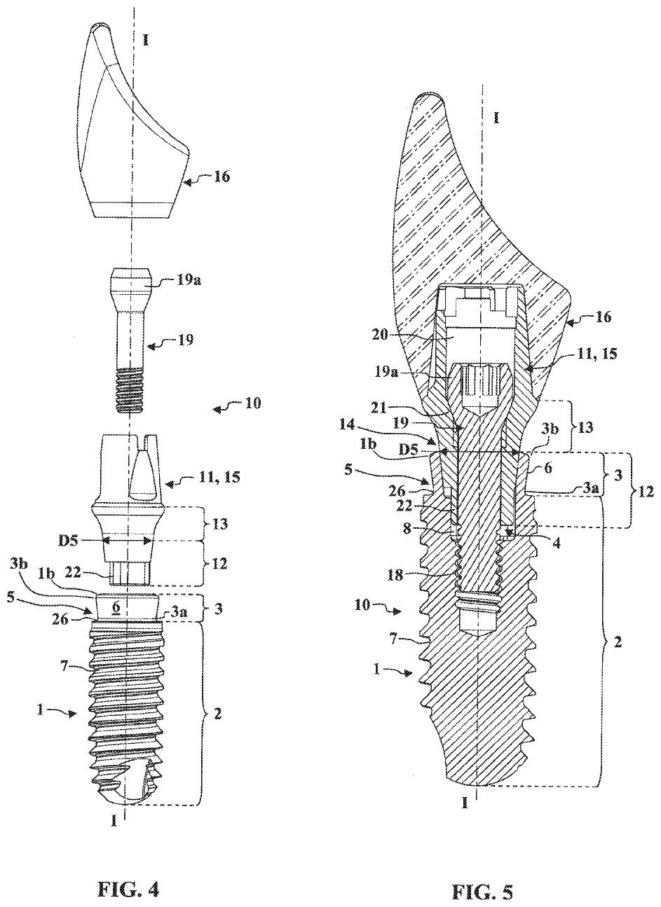

It will be seen more particularly in FIGS. 1 and 3 that the inner connection recess 4 comprises a portion 8 (cylindrical here) of non-circular cross section. The portion 8 more particularly comprises a substantially triangular cross section (with rounded corners). The inner connection recess 4 further comprises an internally threaded proximal portion 18 for receiving, by screwing, a fixation screw (designated 19 in FIGS. 4 to 7).

FIGS. 4 and 5 on the one hand and 6 and 7 on the other hand illustrate an assembly 10 comprising:

a dental implant 1 as illustrated in FIGS. 1 to 3.

a dental prosthetic component 11, comprising a proximal male portion 12 intended to be received by conical fitting in the frustoconical inner bearing surface 9 of the dental implant 1.

In FIGS. 4 and 5, the dental prosthetic component 11 is a dental abutment 15 intended to receive a crown 16 by push-fitting.

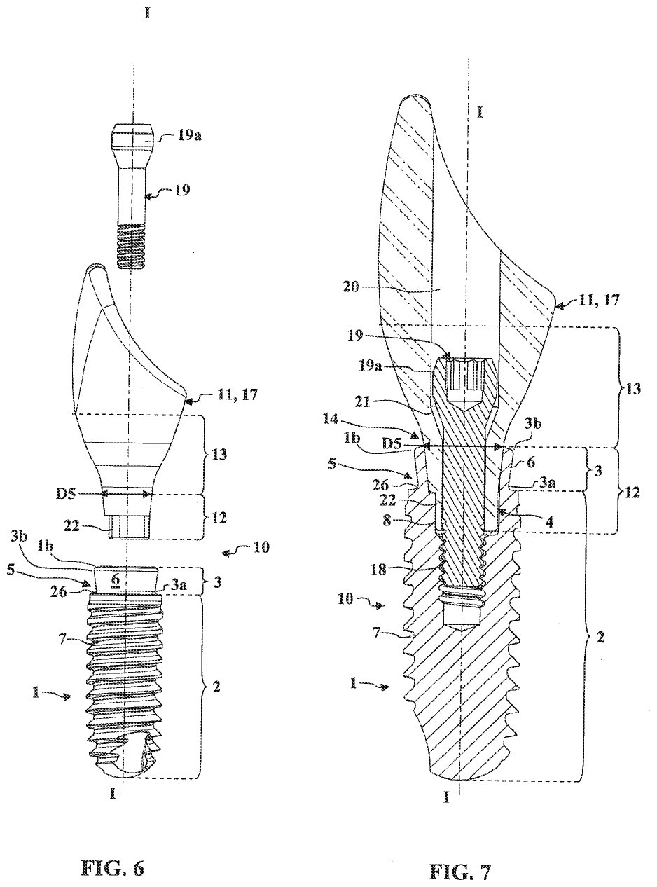

In FIGS. 6 and 7, the dental prosthetic component 11 is a dental prosthesis 17. The dental prosthesis 17 is preferably integrally formed from ceramic. It is obtained for example by machining a ceramic block.

Whether a dental abutment 15 or a dental prosthesis 17, the dental prosthetic component 11 comprises a through-opening 20 for the passage of a fixation screw 19. This through-opening 20 comprises a seat 21 against which the head 19a of the screw 19 is intended to bear in order to retain the dental prosthetic component 11 on the dental implant 1.

The dental prosthetic component 11 comprises a middle portion 13, adjacent to the proximal male portion 12 and having an external cross section which increases progressively away from the proximal male portion 12 so as to form a second annular groove 14 with the distal end 1b of the dental implant 1.

The ratio between the diameter D4 of the top 3b (see FIGS. 1 and 2) and the diameter D5 of the proximal male portion 12 of the dental prosthetic component 11 at the level of said top 3b, when the dental prosthetic component 11 is engaged in the frustoconical inner bearing surface 9 of the dental implant 1 (see FIGS. 4 to 7), is between 1.2 and 1.4.

The proximal male portion 12 (cylindrical here) of the dental prosthetic component 11 comprises a portion 22 of non-circular cross section capable of cooperating (by complementarity of shape in this case) with the portion 8 (also cylindrical) of non-circular cross section of the inner connection recess 4. The portions 8 and 22 thus permit rotation indexing of the dental prosthetic component 11 with respect to the dental implant 1 about the first longitudinal axis I-I.

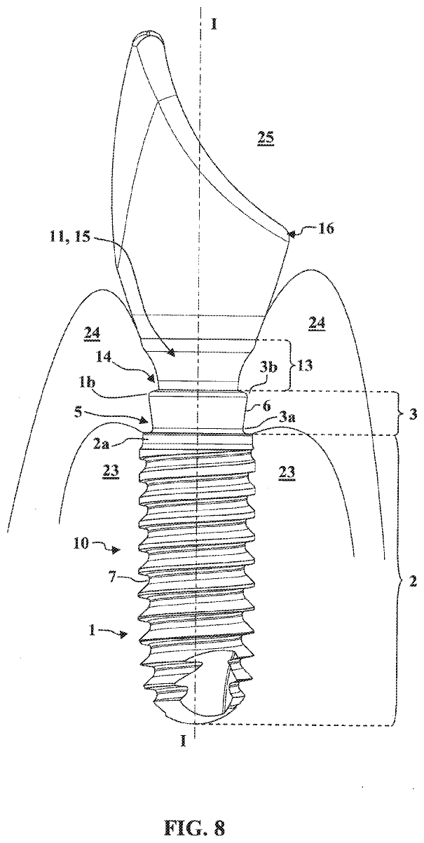

The use of a dental implant 1 and of an assembly 10 according to the invention will now be explained in connection with FIG. 8.

FIG. 8 shows an assembly 10 as illustrated in FIGS. 4 and 5. During the installation, the practitioner drills a hole in the bone 23 (the maxilla or mandible of the patient) to a diameter suitable for receiving the dental implant 1.

The dental implant 1 is then inserted by screwing into the bone 23 until its proximal endosseous portion 2 is embedded completely in the bone 23, as is illustrated in FIG. 8.

The practitioner then sutures the gum 24 around the distal implant portion 3 (and also around a possible healing piece or a temporary prosthetic component inserted into the inner connection recess 4).

During the period of osseointegration of the dental implant 1, the gum 24 heals and forms its conjunctive attachment, at its part immediately adjacent to the bone 23, to a height which depends on the patient but which is generally between 1.2 mm and 1.5 mm around the distal implant portion 3. The conjunctive attachment of the gum 24 thus covers the dental implant 1 through its engagement (along an annular rib) in the first annular groove 5. A baffle is thus formed which limits the risk of impurities entering between the external thread 7 and the bone 23.

Upon removal of the healing piece (or of the temporary prosthetic component), the conjunctive attachment in the lower part of the gum 24 is unaffected along a height of about 1.2 mm to 1.5 mm and remains in a good position around the distal implant portion 3. Any bleeding associated with the rupture of an adherence of the gum 24 to the healing piece during its removal will occur above the distal implant portion 3 and the conjunctive attachment of the gum 24. The risks associated with this bleeding are thus limited by the fact that the conjunctive attachment of the gum 24 provides a good seal between the bone 23 and the oral environment 25 on the other hand.

After removal of the healing piece or of the temporary prosthetic component, the practitioner inserts the dental prosthetic component 11 (here the dental abutment 15) into the inner connection recess 4 of the dental implant 1 and engages it conically by cooperation of the frustoconical inner bearing surface 9 with the proximal male portion 12. The practitioner then inserts the fixation screw 19 into the through-opening and screws it into the internally threaded proximal portion 18 until the head 19a of the fixation screw 19 bears on the seat 21. The dental abutment 15 is then rigidly connected to the dental implant 1, and the practitioner can complete the intervention by placing the crown 16 on the dental abutment 15.

The middle portion 13, adjacent to the proximal male portion 12 and having an external cross section which increases progressively away from the proximal male portion 12, forms a second annular groove 14 with the distal end 1b of the dental implant 1. This second groove 14 subsequently receives part of the gum 24 along an annular rib which opposes corono-apical displacement of the epithelial attachment of the gum 24 (located above the conjunctive attachment).

Finally, the gum 24 forms two annular ribs engaging in the two grooves 5 and 14. These two ribs permit still better stability of the bone 23 under the gum 24.

The engagement of the gum 24 in the second groove 14 also limits the risk of the gum receding in the direction of the proximal end 1a of the dental implant 1. In FIG. 8, the dental implant 1 has only partial transmucosal penetration. In other words, the dental implant 1 protrudes from the bone 23 only by a height less than the height of the gum 24. All of this helps to limit the risks of the dental implant 1 becoming visible.

When cleaning teeth with dental floss, it sometimes happens, with known dental implants, that the dental floss penetrates the conjunctive attachment of the gum and even breaks it. This causes bleeding, in the immediate vicinity of the dental implant and of the bone, and a deterioration of the sealing barrier that is formed by the gum between the bone and the oral environment.

With the assembly according to the present invention, the risk of the conjunctive attachment of the gum being damaged by dental floss is limited here by means of the second annular groove 14 formed just above the distal implant portion 3 after the dental prosthetic component 11 has been joined to the dental implant 1. Indeed, when the dental floss descends along the dental prosthetic component 11 (bearing radially on said dental prosthetic component 11), it enters the second groove 14, which prevents it from moving farther toward the proximal end 1a if the patient does not release the tension exerted by pulling on the two strands of the dental floss. Upon penetration of the dental floss into the second groove 14, the dental floss jolts in a way that is perceptible to the patient, and the latter then spontaneously stops lowering the dental floss along the first longitudinal axis I-I. The conjunctive attachment of the gum formed in the first groove 5 is then preserved from any damage caused by contact with the dental floss.

The use of the assembly 10 illustrated in FIGS. 6 and 7 is similar to the use of the assembly 10 of FIGS. 4 and 5 explained above.

The present invention is not limited to the embodiments that have been explicitly described, and instead it includes the various alternative forms and generalizations thereof contained within the scope of the attached claims.

1-13. (canceled)

14. A dental implant extending along a first longitudinal axis (I-I) between a proximal end and a distal end, comprising:
a proximal endosseous portion intended to be embedded in the jawbone of the patient,
a distal implant portion continuing the proximal endosseous portion away from the proximal end and intended to protrude from the jawbone of the patient, said distal implant portion comprising an outer surface having a roughness Ra of less than or equal to 0.2 μm,
an inner connection recess extending from the distal end and in the direction of the proximal end,
wherein:
the distal implant portion extends by a height (H) along the first longitudinal axis (I-I) in the direction of the distal end from a base to a top, widening from the base to the top in the direction away from the first longitudinal axis (I-I),
the base has a diameter (D1) smaller than a diameter (D2) of the adjacent proximal endosseous portion, so as to form a first annular groove,
the height (H) by which the distal implant portion extends from its base to its top is between 1.2 mm and 1.5 mm.

15. The dental implant as claimed in claim 14, having a maximum external diameter (D3) of less than or equal to 3 mm.

16. The dental implant as claimed in claim 14, wherein the ratio between the diameter (D2) of the adjacent proximal endosseous portion and the diameter (D1) of the base is between 1.09 and 1.50.

17. The dental implant as claimed in claim 14, wherein the endosseous portion is provided with an external thread which extends in the direction of the distal end of the dental implant and is interrupted before the first annular groove.

18. The dental implant as claimed in claim 14, wherein the dental implant is made of titanium, or titanium alloy, or of zirconia, or zirconia alloy.

19. The dental implant as claimed in claim 14, wherein the distal implant portion is anodized in a pink color.

20. The dental implant as claimed in claim 14, wherein the inner connection recess comprises a portion of non-circular cross section.

21. The dental implant as claimed in claim 14, wherein the inner connection recess comprises, in the distal implant portion, a frustoconical inner bearing surface widening toward the distal end away from the first longitudinal axis (I-I).

22. The dental implant as claimed in claim 21, wherein the distal implant portion comprises a frustoconical outer surface having an angle (A2) substantially equal to that (A1) of the frustoconical inner bearing surface.

23. An assembly comprising:
a dental implant as claimed in claim 21,
a dental prosthetic component in the form of a dental abutment or dental prosthesis, comprising a proximal male portion intended to be received by conical fitting in the frustoconical inner bearing surface of the dental implant,
in which the dental prosthetic component comprises a middle portion, adjacent to the proximal male portion and having an external cross section that increases progressively away from the proximal male portion so as to form a second annular groove with the distal end of the dental implant.

24. The assembly as claimed in claim 23, wherein the ratio between the diameter (D4) of the top and the diameter (D5) of the proximal male portion of the dental prosthetic component, located at said top when the dental prosthetic component is fitted into the frustoconical inner bearing surface of the dental implant, is between 1.2 and 1.4.

25. The assembly as claimed in claim 23, wherein:
the dental prosthetic component is in the form of a screw-retained dental abutment or screw-retained dental prosthesis, comprising a through-opening for the passage of a fixation screw,
the inner connection recess comprises an internally threaded proximal portion intended to receive the fixation screw by screwing.

26. The assembly as claimed in claim 23, wherein:
the inner connection recess comprises a portion of non-circular cross-section,
the proximal male portion of the dental prosthetic component comprises a portion of non-circular cross section adapted to cooperate with the portion of non-circular cross section of the inner connection recess for rotational indexing of the dental prosthetic component with respect to the dental implant about the first longitudinal axis (I-I).
